(19) United States
(12) Patent Application Publication
(10) Pub. No.: US 2014/0098248 A1
(43) Pub. Date: Apr. 10, 2014

(54) COMMUNICATION APPARATUS

(71) Applicant: Panasonic Corporation, Osaka (JP)

(72) Inventor: Yoshinori OKAZAKI, Osaka (JP)

(73) Assignee: Panasonic Corporation, Osaka (JP)

(21) Appl. No.: 14/101,775

(22) Filed: Dec. 10, 2013

Related U.S. Application Data
(63) Continuation of application No. PCT/JP2013/000619, filed on Feb. 5, 2013.

(30) Foreign Application Priority Data
Feb. 8, 2012 (JP) 2012-024703

(51) Int. Cl. H04N 1/00

(52) U.S. Cl. CPC H04N 1/00307
USPC 348/207.1

(57) ABSTRACT

A communication apparatus includes a receiver that receives an instruction to switch off the communication apparatus, an obtaining unit that obtains data from a recording medium, a communication unit that sends the obtained data to an other electronic device, and a controller that controls power supply of the communication apparatus. The controller continuously supplies power at least to a predetermined component which needs power to be supplied to establish communication with the other electronic device for a predetermined period of time when the receiver receives the instruction to switch off the communication apparatus.

### BACKGROUND

1. Technical Field

The present disclosure relates to a communication apparatus which can communicate with another apparatus.

2. Related Art

Patent Document 1 (JP2007-158604A) discloses an imaging apparatus which records a captured image in an external recording medium according to a capturing instruction, while sending the captured image to an other device by a wireless communication function. The imaging apparatus described in Patent Document 1 has a temporary storage unit which temporarily stores a captured image, a determining unit which determines interruption of a wireless communication function, and a control unit which performs a control, in the case where the determining unit determines the interruption of the wireless communication function, to interrupt transmission of a captured image to an other device which is performed by the wireless communication function and continue a recording operation of the captured image temporarily stored in the temporary storage unit into an external recording medium.

### SUMMARY

When one communication apparatus transfers data to the other communication apparatus, the one communication apparatus requires a user to operate both of the one communication apparatus and the other communication apparatus, resulting in inconvenience to users.

The present disclosure provides a communication apparatus with improved convenience to users in transferring data to the other communication apparatus.

A communication apparatus according to the present disclosure includes a receiver that receives an instruction to switch off the communication apparatus, an obtaining unit that obtains data from a recording medium, a communication unit that sends the obtained data to an other electronic device, and a controller that controls power supply of the communication apparatus. The controller continuously supplies power at least to a predetermined component which needs power to be supplied to establish communication with the other electronic device for a predetermined period of time, when the receiver receives the instruction to switch off the communication apparatus.

According to the communication apparatus of the present disclosure, the user is not required to operate both of the communication apparatus and another electronic device at the same time in transferring data to the other communication apparatus. Therefore, the communication apparatus of the present disclosure can improve convenience to an user in transferring data to the other electronic device.

### BRIEF DESCRIPTION OF DRAWINGS

FIG. 1 is a diagram indicating a communication system including a digital camera and a smart phone according to a first embodiment.

FIG. 2 is a diagram indicating an electrical configuration of the digital camera according to the first embodiment.

FIG. 3 is a diagram indicating an electrical configuration of the smart phone according to the first embodiment.

FIG. 4 is a flow chart for describing operations of the digital camera in a communication between the digital camera and the smart phone according to the first embodiment.

FIG. 5 is a diagram illustrating a GUI for selecting the image to be sent.

FIGS. 6A to 6C are diagrams for describing usage examples of the digital camera and the smart phone which are used by a user.

FIG. 7 is a flow chart for describing operations of a digital camera in a communication between a digital camera and a smart phone according to a second embodiment.

FIG. 8 is a flow chart for describing operations of a digital camera in a communication between a digital camera and a smart phone according to a third embodiment.

### DETAILED DESCRIPTION OF PREFERRED EMBODIMENTS

Embodiments will be described below with reference to drawings. A digital camera will be taken as an example of the embodiments.

In the description of the present disclosure, certain unnecessary portions regarding, for example, conventional technology, redundant description on substantially the same configuration may be omitted for ease of description.

The following description and the attached drawings are disclosed to enable those skilled in the art to sufficiently understand the present disclosure, and are not intended to limit the subject matter of the claims.

### 1. First Embodiment

The configuration and operation of a digital camera and a smart phone according to the first embodiment will be described below.

### 1-1. Configuration

The configuration of a system and the configuration of the digital camera and smart phone according to the present embodiment will be described below with reference to the drawings.

### 1-1-1. Configuration of Communication System Including Digital Camera and Smart Phone

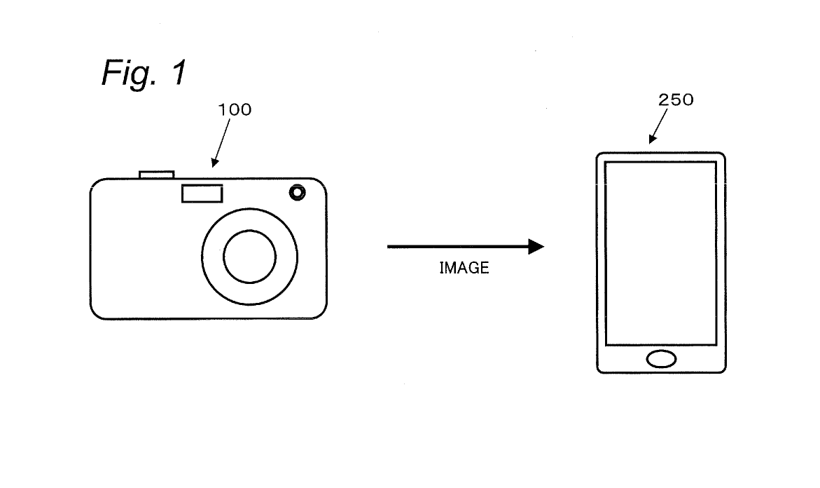

The configuration of a system including the digital camera and the smart phone according to the present embodiment will be described with reference to FIG. 1.

The communication system according to the present embodiment includes a digital camera 100 and a smart phone 250.

The digital camera 100 includes a communication unit for communicating with the smart phone 250. The digital camera 100 can send data of a captured image to be displayed on a recording standby screen (hereinafter, referred to as “through image”) and data of an image recorded on a recording medium (hereinafter, referred to as “recorded image”) to the smart phone 250. The digital camera 100 can also send data of a recorded image newly obtained by shooting operation to the smart phone 250.

The smart phone 250 includes a communication unit for communicating with the digital camera 100. The smart phone 250 receives the through image and the recorded image sent from the digital camera 100. By receiving the through image from the digital camera 100, the smart phone 250 can display the through image on a display unit included in the smart phone 250.

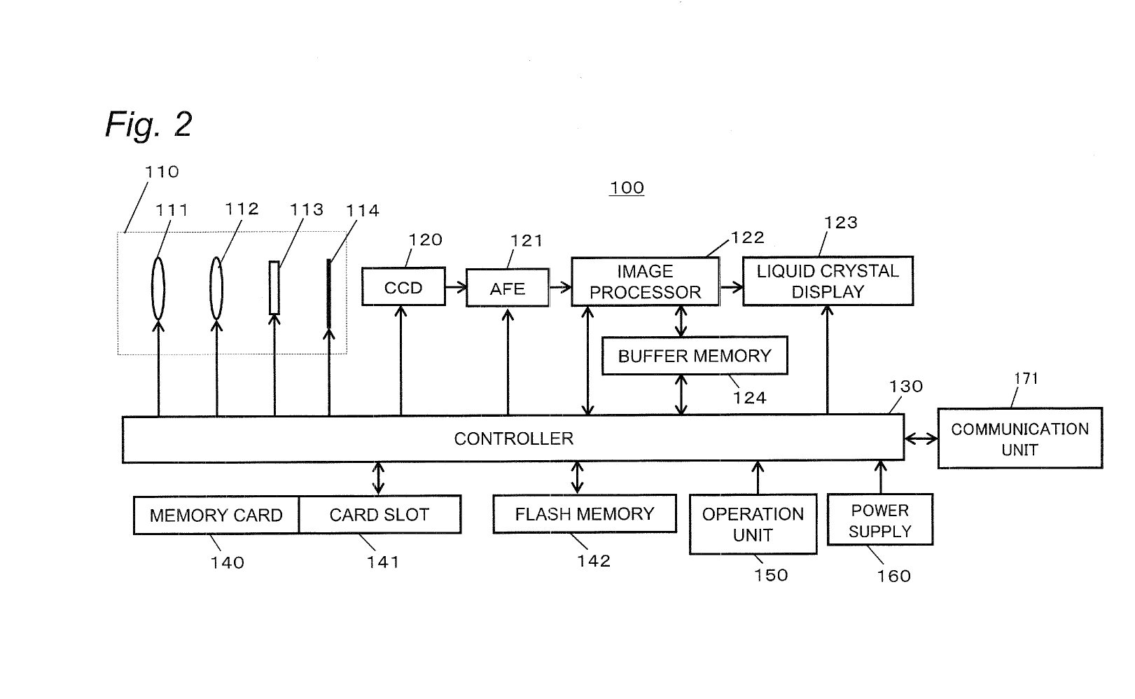

FIG. 2 is a diagram indicating an electrical configuration of the digital camera 100.

The digital camera 100 includes an optical system 110, a CCD image sensor 120, an AFE (Analog Front End) 121, an image processor 122, a liquid crystal display 123, a buffer memory 124, a controller 130, a card slot 141 that can store a memory card 140, a flash memory 142, an operation unit 150, a power supply 160, and a communication unit 171.

The digital camera 100 captures a subject image formed through the optical system 110, by the CCD image sensor 120. The CCD image sensor 120 generates image data based on the captured subject image. The image data generated by image capturing is subject to various types of processing in the AFE 121 and the image processor 122. The generated image data is stored in the flash memory 142 and/or the memory card 140. The image based on the image data recorded in the flash memory 142 and/or the memory card 140 is displayed on the liquid crystal display 123 according to operations on the operation unit 150 by a user.

The optical system 110 includes a focus lens 111, a zoom lens 112, a diaphragm 113, and a shutter 114. Note that the optical system 110 may include an optical image stabilizer lens OIS (not shown). Further, the optical system 110 may include any number of various types of lens or any number of various types of lens groups.

The CCD image sensor 120 captures a subject image formed through the optical system 110 and generates image data. The CCD image sensor 120 generates a new frame of image data at a predetermined frame rate (for example, 30 frames/second). The timing of image data generation by the CCD image sensor 120 and an electronic shutter operation of the CCD image sensor 120 are controlled by the controller 130. With the image data successively displayed on the liquid crystal display 123 as a through image, the user can confirm the situation of the subject on the liquid crystal display 123 in real time.

The AFE 121 performs noise suppression by correlated double sampling, multiplication of gain based on an ISO sensitivity value by an analog gain controller, and A/D conversion by an A/D converter on the image data generated at the CCD image sensor 120. Then, the AFE 121 outputs the image data to the image processor 122.

The image processor 122 performs various types of processing on the image data output from the AFE 121. The various types of processing include, but not limited to, BM (block memory) accumulation, smear correction, white balance correction, gamma correction, YC conversion process, electronic zoom process, compression process, and/or expansion process. The image processor 122 may be composed of a hardwired electronic circuit, or a microcomputer using a program or the like. The image processor 122 may also be made into a single semiconductor chip together with the controller 130 and so on.

The liquid crystal display 123 is provided on the back surface of the digital camera 100. The liquid crystal display 123 displays an image based on the image data processed by the image processor 122. The liquid crystal display 123 displays the images such as a through image and a recorded image.

The controller 130 controls the operations of the entire digital camera 100. The controller 130 also has a access point function. The controller 130 may be composed of a hardwired electronic circuit, or may be composed of a microcomputer or the like. The controller 150 may also be made into a single semiconductor chip together with the image processor 122 and so on.

The flash memory 142 functions as an internal memory for recording the image data and the like. The flash memory 142 also stores programs related to autofocus control (AF control), communication control, programs for controlling the operations of the entire digital camera 100, and so on.

The buffer memory 124 is a storing section that functions as a work memory for the image processor 122 and the controller 130. The buffer memory 124 can be implemented by a DRAM (Dynamic Random Access Memory) or the like.

The card slot 141 is a connecting section that can store the memory card 140. The card slot 141 can be connected with the memory card 140 electrically and mechanically. The card slot 141 may also be provided with a function for controlling the memory card 140.

The memory card 140 is an external memory that contains a recording element such as the flash memory. The memory card 140 can store data such as the image data processed in the image processor 122.

The communication unit 171 is a wireless or wired communication interface. The controller 130 can be connected to an internet network via the communication unit 171 and an access point. For example, the communication unit 171 can be implemented by a USB, Bluetooth (registered trademark), a wireless LAN, a wired LAN, or the like.

A power supply 160 supplies power to the various components of the digital camera 100. The power supply 160 may be a battery stored in the digital camera 100 or may be adapted to be powered from an external AC power supply via a cable.

An operation unit 150 includes operation buttons, an operation levers, and/or a power switch which are/is provided on the exterior of the digital camera 100. The operation unit 150 receives operations from a user. When receiving an operation from the user, the operation unit 150 sends signals to instruct the controller 130 to perform various operations. The power switch is for starting or stopping the supply of power from the power supply 160 to the digital camera 100 (i.e., for switching the power supply 160 of the digital camera 1000N state and OFF state).

### 1-1-3. Configuration of Smart Phone

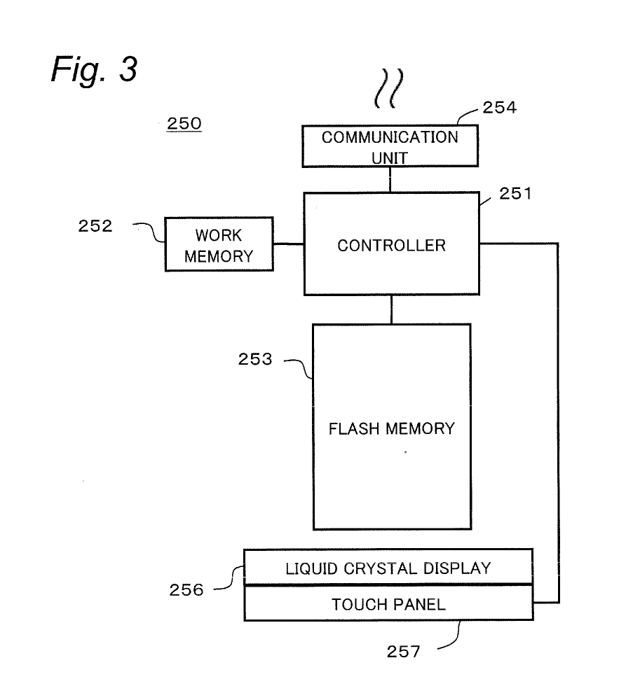

A configuration of the smart phone 250 will be described with reference to FIG. 3. FIG. 3 is a diagram indicating an electrical configuration of the smart phone 250.

The smart phone 250 includes a controller 251, a work memory 252, a flash memory 253, a communication unit 254, a liquid crystal display 256, a touch panel 257. The smart phone 250 may include an image capturing unit and/or an image processor.

The controller 251 is a processing section for performing processing on the smart phone 250. The controller 251 is electrically connected to the work memory 252, the flash memory 253, the communication unit 254, the liquid crystal display 256, and the touch panel 257. The controller 251 receives operations performed on the touch panel 257 from the user. The controller 251 can store data in the flash memory 253 and read data from the flash memory 253. The controller 251 also controls a system relating to power supplied to the respective unit of the smart phone 250, or the like. Further, the controller 251 performs the telephone function and the various applications downloaded via the Internet.

The work memory 252 is a memory for temporarily storing information necessary for the controller 251 to execute the various processing operations.

The flash memory 253 is a disk drive with a large capacity for storing various types of data. As described above, the respective types of data stored in the flash memory 253 can be read by the controller 251 as required. Although the smart phone 250 has the flash memory 253 in the present embodiment, the smart phone 250 may have a recording media other type than the flash memory (hard disk drive or the like).

The liquid crystal display 256 is a display device which displays a screen specified by the controller 251.

The touch panel 257 is an input device for receiving operations from the user. Although the smart phone 250 has the touch panel 257 as the input device for receiving operations from the user in the present embodiment, the smart phone 250 may have an input device other than the touch panel 257 (hard keys or the like).

The communication unit 254 can input to the controller 251 data which is received from other device(s) via the internet network, and send image data received from the controller 251 to the other device(s) via the internet network. The communication unit 254 can be implemented by, for example, a wired LAN or a wireless LAN.

### 1-2. Operation of Digital Camera

The operation of the digital camera 100 will be described below. First, a basic operation of the digital camera 100 will be described, and then, the operation of the digital camera 100 in communication between the digital camera 100 and the smart phone 250 will be described.

### 1-2-1. Basic Operation of Digital Camera

When the digital camera 100 is switched ON state, the controller 130 of the digital camera 100 supplies power to the respective components of the digital camera 100 and controls the digital camera 100 to be ready for image shooting.

The digital camera 100 has a shooting mode and a playback mode. When the digital camera 100 is set to the shooting mode, the controller 130 displays the through image based on image data captured by the CCD image sensor 120 from a subject image which is input through an optical system 110, on the liquid crystal display 123.

With the through image displayed on the liquid crystal display 123, the user can confirm whether an angle of view and the like of the subject are as desired to be recorded by viewing the through image displayed on the liquid crystal display 123. In response to pressing on a release button by the user with desired timing, an image captured at the timing by the CCD image sensor 120 is processed by an image processor 122 and recorded in a memory card 140 as a recorded image.

On the other hand, when the digital camera 100 is set to the playback mode, the controller 130 reads an image recorded in the memory card 140 and displays the read image on the liquid crystal display 123 to allow the user to confirm the recorded image.

### 1-2-2. Communication Operation of Digital Camera

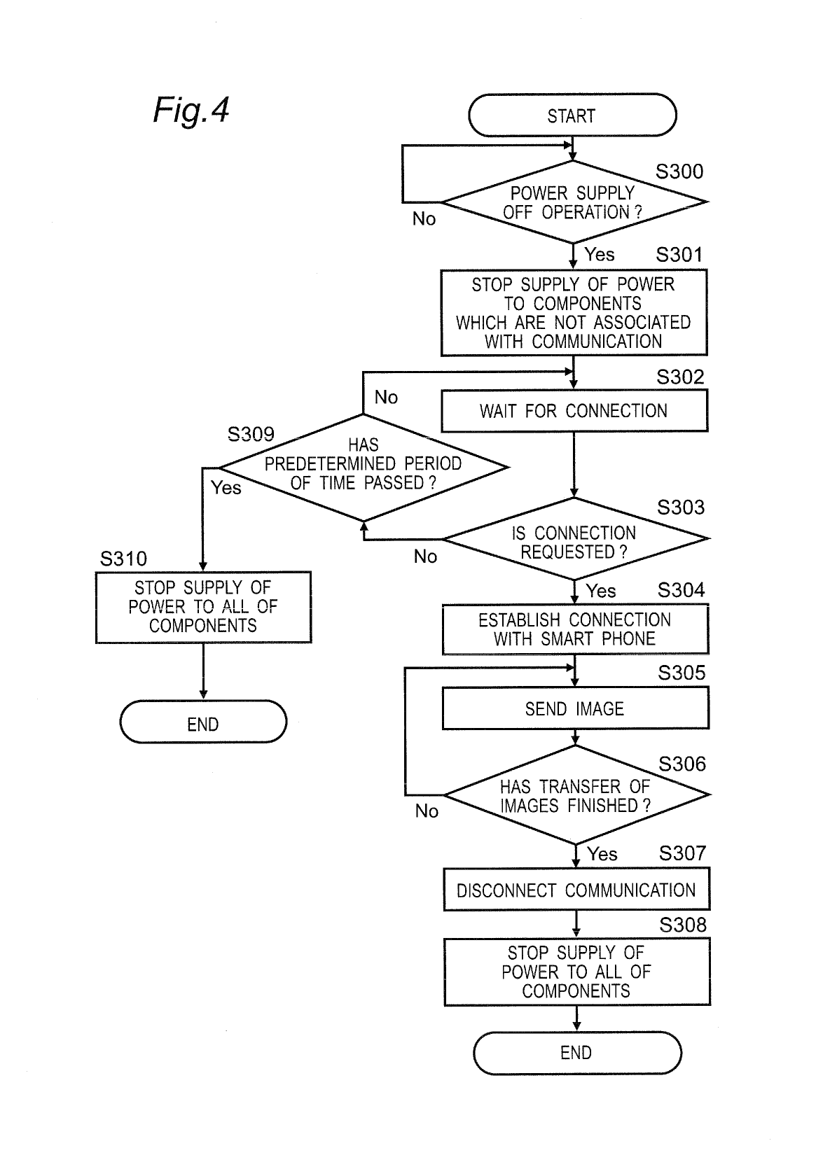

The operation of the digital camera 100 in communication between the digital camera 100 and the smart phone 250 will be described with reference to FIG. 4. FIG. 4 is a flow chart illustrating the operation of the digital camera 100 in communication between the digital camera 100 and the smart phone 250.

While the power supply of the digital camera 100 is in ON state, the controller 130 determines whether the user operates the operation unit 150 to issue a power supply OFF instruction (power supply OFF operation) (S300).

The controller 130 keeps the digital camera 100 in the power supply ON state as long as the power supply (battery or the like) continues to supply power until the user performs the power supply OFF operation (No in step S300).

On the other hand, when detecting that the user performs the power supply OFF operation (Yes in step S300), the controller 130 stops the supply of power to some components which require power to be supplied (S301). That is, when the power supply OFF operation is performed by the user, the digital camera 100 switches a part of the power supplies to the OFF state.

Herein, some components to which the supply of power is stopped are components which are not associated with a communication function. Specifically, the components which are not associated with the communication function include an image shooting unit which only relates to image shooting including the CCD image sensor 120, the AFE 121, and a driver for driving the optical system 110, a display unit such as the liquid crystal display 123, and the like. That is, when the power supply OFF operation is performed by the user, the controller 130 controls the respective components to stop the supply of power to the components which are not associated with the communication function.

As a result, the power consumption of the digital camera 100 during the standby period before start of the communication between the digital camera 100 and the smart phone 250 can be reduced as compared with the case where the power is supplied to all of the components.

At this moment, the controller 130 continues the supply of power to the components which are associated with the communication function such as the communication unit 171 and the components which may be used in the communication (the memory card 140, the card slot 141, and the flash memory 142). Further, the controller 130 keeps an access point function of the digital camera 100 active.

Then, the controller 130 of the digital camera 100 waits for reception of a connection request from a communication apparatus such as the smart phone 250 for a predetermined period of time (S302). Herein, the predetermined period of time may be, for example, several minutes or about an hour. At this time, the controller 130 of the digital camera 100 is keeping the access point function active to be ready to allow the communication apparatus (client apparatus) such as the smart phone 250 to connect with the digital camera 100. As a result, the communication apparatus such as the smart phone 250 can find the digital camera 100 as a connection partner.

While waiting, the controller 130 of the digital camera 100 determines whether a connection request is sent from the smart phone 250 to the digital camera 100 (S303). Since the digital camera 100 keeps the access point function active even after the power supply OFF operation, the smart phone 250 which is to be a client can find the digital camera 100 as a connection partner. Also, the controller 130 of the digital camera 100 determines whether the predetermined period of time for waiting for a connection request has passed (S309).

Until the predetermined period of time for waiting for a connection request passes (No in step S309), the controller 130 of the digital camera 100 repeats the operations of the waiting for reception of connection (S302), the determining of connection request (S303), and the determining on whether the predetermined period of time has passed (S309).

When the predetermined period of time passes without a connection request sent from the smart phone 250 (Yes in step S309), the controller 130 of the digital camera 100 stops the supply of power to all of the components of the digital camera 100 (S310). That is, since the controller 130 has stopped the supply of power to the components which are not associated with the communication function (S301), the controller 130 of the digital camera 100 stops the supply of power to the rest of the components which are associated with the communication function (the communication unit 171, the memory card 140, the card slot 141, and the like). As a result, the digital camera 100 completely enters the switched OFF state, and thus the digital camera 100 enters a non-operating state.

On the other hand, when a connection request is sent from the smart phone 250 (Yes in step S303), the digital camera 100 performs a connection operation to the smart phone 250 via the communication unit 171 and the communication unit 254 (S304). Specifically, the digital camera 100 establishes the communication with the smart phone 250 by connecting with the smart phone 250 in the following procedure.

Since the digital camera 100 keeps the access point function active, the controller 251 of the smart phone 250 can specify the digital camera 100 as a connection partner based on a list of available access points.

Note that, when specifying the connection partner, the smart phone 250 may automatically specify an available access point or may specify an access point specified by the user. In the case where the smart phone 250 specifies an access point specified by the user, the smart phone 250 may automatically specify the connection partner (the digital camera 100) specified by the user after the second time of specifying the connection partner.

When the controller 251 of the smart phone 250 specifies the digital camera 100 as the connection partner, the controller 251 sends a connection request to the digital camera 100 via the communication unit 254. When the controller 130 of the digital camera 100 receives the connection request from the smart phone 250 via the communication unit 171, the controller 130 sends information indicating that connection with the digital camera 100 is approved, to the controller 251 of the smart phone 250. However, the information indicating the approval of connection is not sent in the case where such a restriction as a connection restriction is set to the digital camera 100. When the controller 251 of the smart phone 250 receives the information indicating the approval of connection, the communication between the digital camera 100 and the smart phone 250 via the communication unit 171 and the communication unit 254 is established. That is, as long as the digital camera 100 receives the connection request within the predetermined period of time after the power supply OFF operation, the digital camera 100 can establish the communication with the smart phone 250 in response to reception of the connection request from the smart phone 250.

When the communication is established, the controller 130 of the digital camera 100 sends an image in the memory card 140 to the smart phone 250, as the communication partner (S305). The image sent to the smart phone 250 is decided by a predetermined method.

The predetermined method for deciding the image to be sent by the digital camera 100 to the smart phone 250 will be described by using three examples.

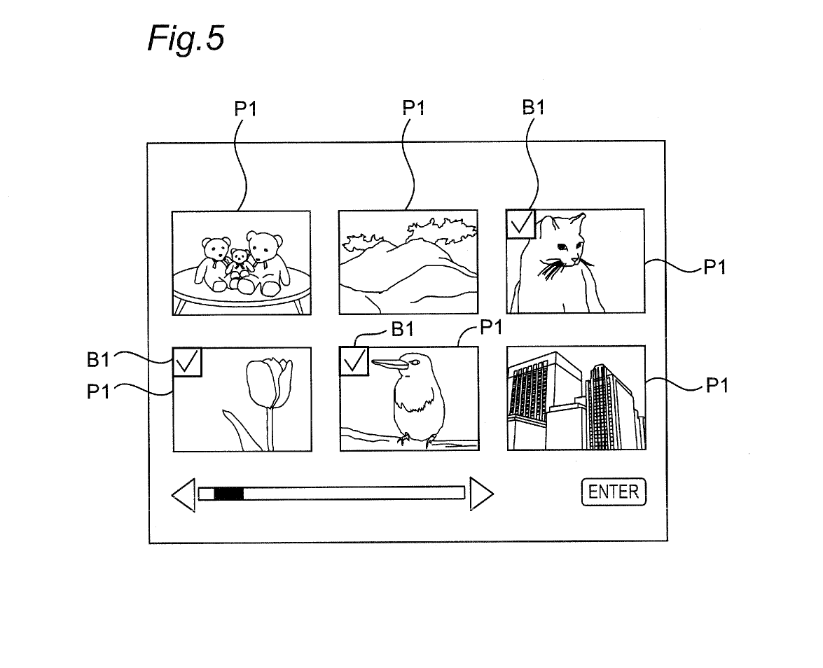

As the first deciding method, the user previously selects one or more images as images to be transmitted in the digital camera 100. Specifically, the images are selected in the following procedure. FIG. 5 is a diagram illustrating a GUI (Graphical User Interface) for selecting the image to be sent. The GUI displays images P1 stored in the memory card 140. In the playback mode, the user selects one or more images to be transmitted by operating the operation unit 150, while viewing the images P1, for example, on the GUI displayed on the liquid crystal display 123. A check mark B1 is displayed on the selected image. When the user finishes selecting the images to be transmitted, the user operates the digital camera 100 to communicate information indicating the completion of selection to the digital camera 100. When the controller 130 of the digital camera 100 receives the operation indicating the completion of selection, the controller 130 creates management information (list) indicating a list of images which are selected by a user for the images to be transmitted and stores the management information in the flash memory 142. Then, when the communication between the digital camera 100 and the smart phone 250 is established (S304), the controller 130 of the digital camera 100 sends the images to the smart phone 250 according to the management information stored in the flash memory 142 (S305).

The second deciding method is as below. The digital camera 100 creates a list of images which have been sent to the smart phone 250 and stores the list in the flash memory 142. When the communication between the digital camera 100 and the smart phone 250 is established (S304), the controller 130 of the digital camera 100 sends the images which have not been sent yet out of the images in the memory card 140 to the smart phone 250 by referring to the list of images which have been sent in the flash memory 142 (S305).

The third deciding method is as below. The smart phone 250 creates a list of images which have been obtained from the digital camera 100 and stores the list in a flash memory 253. When the communication between the digital camera 100 and the smart phone 250 is established (S304), the smart phone 250 sends the digital camera 100 the list of images which have been obtained. Then, the controller 130 of the digital camera 100 creates a list of images which have not been obtained by the smart phone 250 out of the images in the memory card 140 by referring to the received list of images which have been obtained by the smart phone 250. The controller 130 of the digital camera 100 sends the smart phone 250 the images which have not been obtained, by referring to the list of images which have not been obtained by the smart phone 250 (S305).

The digital camera 100 may be previously configured to perform either one of the above three deciding methods. Alternatively, either one of the above three deciding methods may be selected by the user when the user performs the power supply OFF operation.

After the images which have been decided by any one of the above described methods are sent (S305), the controller 130 of the digital camera 100 determines whether an image to be sent to the smart phone 250 is left, i.e., whether the transfer of the images has finished (S306).

In the case where an image to be sent to the smart phone 250 is left, i.e., when the transfer of the images has not finished (No in step S306), the controller 130 of the digital camera 100 continues the transfer of the images to the smart phone 250.

On the other hand, in the case where no image to be sent to the smart phone 250 is left, i.e., when the transfer of the images has finished (Yes in step S306), the controller 130 of the digital camera 100 disconnects the communication with the smart phone 250 (S307). Specifically, the controller 130 of the digital camera 100 stops (inactivates) the access point function. As a result, the smart phone 250 loses the access point via which the communication is established, and thus the communication is disconnected.

When the communication with the smart phone 250 is disconnected, the controller 130 of the digital camera 100 stops the supply of power to all of the components of the digital camera 100 (S308). Since the supply of power to the components which are not associated with the communication function is already stopped when the user performs the power supply OFF operation (S301), the controller 130 of the digital camera 100 stops the supply of power to the rest of the components which are associated with the communication function (the communication unit 171, the memory card 140, the card slot 141, and the like). As a result, the power supply of the digital camera 100 completely enters the OFF state and thus the digital camera 100 enters a non-operating state.

As described above, the digital camera 100 according to the present embodiment waits for reception of a connection request from the smart phone 250 for the predetermined period of time even after the power supply OFF operation. Then, when receiving a connection request from the smart phone 250 within the predetermined period of time, the digital camera 100 establishes the communication with the smart phone 250 to transfer the images to the smart phone 250. Then, when finishing the transfer of the images, the digital camera 100 switches the entire power supply to the OFF state. On the other hand, when the digital camera 100 does not receive a connection request from the smart phone 250 within the predetermined period of time, the digital camera 100 immediately switches OFF the entire power supply. As a result, the digital camera 100 can keep ready to establish the communication with the smart phone 250 for a while after the power supply OFF operation performed on the digital camera 100, and when the digital camera 100 cannot establish the communication with the smart phone 250, the digital camera 100 can immediately switch OFF the power supply.

Therefore, when the user transfers the images from the digital camera 100 to the smart phone 250 after switching OFF the digital camera 100, the user is not required to operate both of the digital camera 100 and the smart phone 250, so that convenience to users can be improved.

### 1-3. Usage Examples of Digital Camera

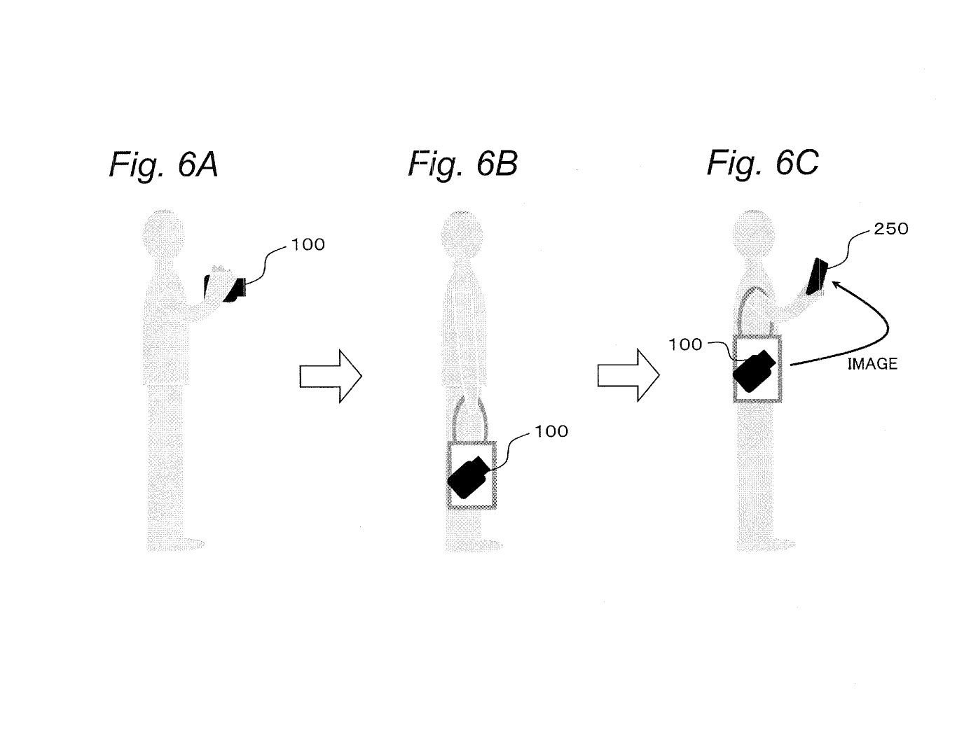

Usage examples of the digital camera 100 of the embodiment will be described with reference to FIGS. 6A to 6C. FIGS. 6A to 6C are diagrams for describing usage examples of the digital camera 100 and the smart phone 250 which are used by a user.

FIG. 6A is a diagram illustrating the user shooting an image of a desired subject by using the digital camera 100. The user is in the state illustrated in FIG. 6A until the user finishes the shooting of the image of the desired subject.

FIG. 6B is a diagram illustrating that the user finishes the image shooting by the digital camera 100 and put the digital camera 100 in a bag (or may be in a pocket or the like). When the user finishes the shooting of the image with the digital camera 100, the user operates the operation unit 150 to switch OFF the digital camera 100 and then puts the digital camera 100 in the bag (a pocket or the like).

FIG. 6C is a diagram illustrating that the user puts the digital camera 100 in the bag and switches on of the smart phone 250. In recent years, as mobile phones and portable terminals such as the smart phone 250 have become widely used, an increasing number of people spend their free time using the smart phones 250. After the “task” of the shooting of an image with the digital camera 100, for example, some of the users tend to perform something by using the smart phone 250 such as browsing of web pages or checking of social network sites. At that time, since the digital camera 100 according to the present embodiment is put in the bag or the like still has the communication function active even after the power supply OFF operation, the smart phone 250 can communicate with the digital camera 100. When the communication with the smart phone 250 is established, the digital camera 100 is enabled to start transferring the image. Then, when the digital camera 100 finishes transferring the image to the smart phone 250, the digital camera 100 switches itself to the OFF state without requiring a user operation.

As described above, when the user transfers data to the smart phone 250 within a predetermined period of time after switching OFF the digital camera 100 according to the present embodiment, the user is not required to operate both of the digital camera 100 and the smart phone 250 at the same time. Therefore, convenience can be improved.

### 1-4. Conclusion

The digital camera 100 according to the present embodiment includes the operation unit 150 that receives an instruction to switch off the digital camera 100, the controller 130 that obtains data from a recording medium, the communication unit 171 that sends the obtained data to the smart phone 250, and the controller 130 that controls power supply of the digital camera 100. The controller 130 continuously supplies power at least to a predetermined component which needs power to be supplied to establish communication with the smart phone 250 for a predetermined period of time, when the operation unit 150 receives the instruction to switch off the digital camera 100.

According to the digital camera 100 with the above described configuration, when images are transferred from the digital camera 100 to the smart phone 250, the user is not required to operate both of the digital camera 100 and the smart phone 250 at the same time. Therefore, the present embodiment can improve convenience as compared with the case where the user operates both of the digital camera 100 and the smart phone 250 at the same time.

### 2. Second Embodiment

The second embodiment will be described.

In the first embodiment, the images to be sent to the smart phone 250 are selected before the power supply OFF operation is performed on the digital camera 100. Then, when the communication between the digital camera 100 and the smart phone 250 is established after the power supply OFF operation, the digital camera 100 sends the selected images to the smart phone 250.

In contrast, in the present embodiment, images to be sent to the smart phone 250 are selected on the smart phone 250 after the communication between the digital camera 100 and the smart phone 250 is established within a predetermined period of time after the power supply OFF operation. The configuration and the operation of the digital camera 100 except for the above described ones are the same as those of the first embodiment.

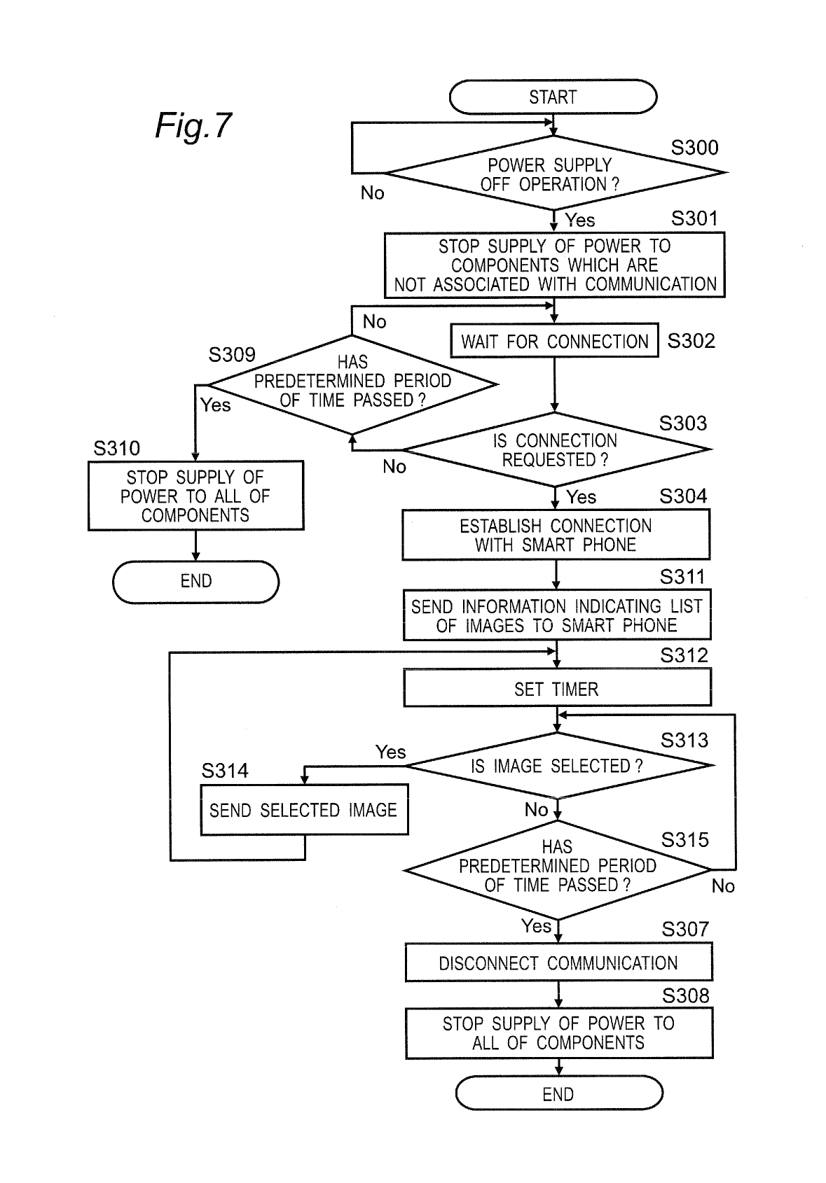

The operation of the digital camera 100 according to the present embodiment will be described with reference to FIG. 7. As illustrated in FIG. 7, the digital camera 100 according to the present embodiment performs the same operations after the power supply is switched to the ON state until the communication between the digital camera 100 and the smart phone 250 is established (steps S300 to S304, and S309 to S310) as those of the first embodiment.

Then, when the communication is established, the digital camera 100 according to the present embodiment sends information indicating a list of images in the flash memory 142 to the smart phone 250 (S311) and initializes a timer (S312). Hereinafter, the information indicating a list of images will be referred to as “list information”.

When receiving the list information, the smart phone 250 displays a GUI on the liquid crystal display 256 for allowing the user to select images to be sent from the digital camera 100 to the smart phone 250. For example, the GUI illustrated in FIG. 5 is displayed. With the GUI, the user can select images as in the case where the user selects images on the digital camera 100.

When the selection of the image is completed, the smart phone 250 sends information indicating the completion of the image selection to the digital camera 100.

After sending the list information, the controller 130 of the digital camera 100 determines whether an image to be sent from the digital camera 100 to the smart phone 250 is selected by the user (S313). The determination of the image selection is performed based on whether the digital camera 100 has received the information indicating the completion of the image selection from the smart phone 250.

When the controller 130 of the digital camera 100 determines that an image to be sent from the digital camera 100 to the smart phone 250 has been selected by the user (Yes in step S313), the controller 130 sends the selected image(s) to the smart phone 250 (S314). Then, the digital camera 100 initializes the timer (S312).

On the other hand, when the digital camera 100 determines that an image to be sent from the digital camera 100 to the smart phone 250 has not been selected by the user (No in step S313), the digital camera 100 determines whether the time measured by the timer exceeds a predetermined period of time (for example, several minutes) (S315).

When the digital camera 100 determines that the time measured by the timer has not exceeded the predetermined period of time (No in step S315), the digital camera 100 determines whether an image to be sent from the digital camera 100 to the smart phone 250 is selected by the user again (S313).

On the other hand, when the digital camera 100 determines that the time measured by the timer has exceeded the predetermined period of time (Yes in step S315), the digital camera 100 disconnects the communication with the smart phone 250 (S307) and stops the supply of power to all of the components of the digital camera 100 (S308).

Also by the above described operation, the present embodiment can improve convenience of the case where images are sent from the digital camera 100 to the smart phone 250 as in the first embodiment.

In the present embodiment, after the establishment of the communication, the supply of power to all of the components of the digital camera 100 is stopped (S308) on the condition that no image is selected within the predetermined period of time (Yes in step S315). However, the supply of power to all of the components of the digital camera 100 may be stopped on the condition that an operation of switching OFF the digital camera 100 is performed on the smart phone 250 instead of the condition that an image is selected on the smart phone 250.

### 3. Third Embodiment

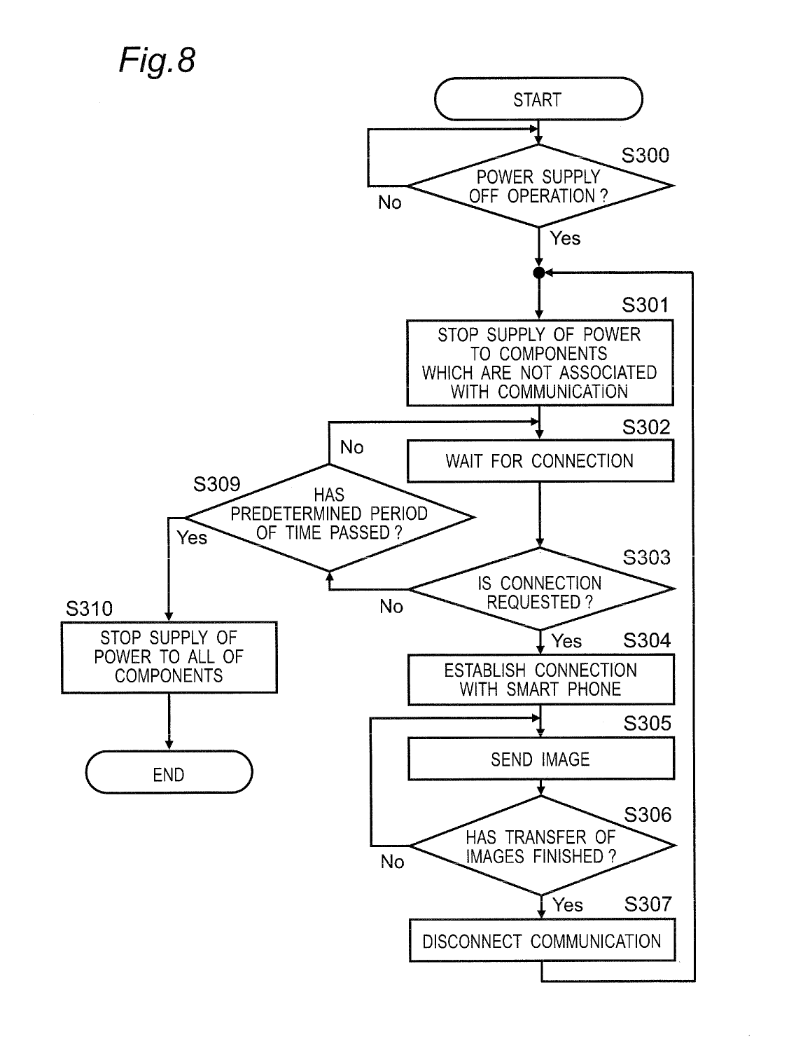

The third embodiment will be described with reference to FIG. 8. The configuration and the operation of the digital camera 100 according to the present embodiment except for a part of the operation are the same as those of the first embodiment.

After the digital camera 100 according to the first embodiment finishes transferring the images to the smart phone 250 (Yes in step S306), the digital camera 100 disconnects the communication with the smart phone 250 (S307) and then stops the supply of power to all of the components (S308). On the other hand, in the case of the digital camera 100 according to the present embodiment, after digital camera 100 finishes transferring the image (Yes in step S306), digital camera 100 disconnects the communication with the smart phone 250 (S307) and keeps the supply of power to the minimal components which are associated with communication for a predetermined period of time to be ready for accepting the connection from outside again (S302), instead of stopping the supply of power to all of the components.

As a result, the digital camera 100 can keep ready for accepting the connection from a device different from the device which was connected a moment ago, for example.

Also by the above described operation, the present embodiment can improve convenience of the case where images are sent from the digital camera 100 to the smart phone 250 as in the first embodiment.

### 4. Other Embodiments

The idea of the above described embodiment is not limited to the embodiment described above. Various embodiments may also be considered. Other embodiments to which the idea of the above described embodiment can be applied will be described below.

In the present embodiment, the smart phone 250 is used as an example of the communication apparatus which communicates with the digital camera 100. However, an apparatus other than the smart phone 250 may be used as the communication apparatus which communicates with the digital camera 100.

In the above described embodiments, an image data is sent to the smart phone 250. However, the idea of the above described embodiments is not limited to the sending of image data. Data other than the image data may be sent to the smart phone 250. For example, moving image data, voice data, or document data may be sent.

When the power supply OFF operation is performed (Yes in step S300), the digital camera 100 according to the above described embodiments keeps the supply of power to the memory card 140 and the card slot 141 (S301). However, the idea of the above described embodiments is not limited to that. When the power supply OFF operation is performed, the supply of power to the components which are not needed to establish the communication (the memory card 140, the card slot 141, and the like) may be stopped. However, in that case, when the communication between the digital camera 100 and the smart phone 250 is established, the digital camera 100 supplies power to the memory card 140 and the card slot 141. In a word, while waiting for a connection request from the smart phone 250 (steps S302 to S303, and S309), the digital camera 100 supplies power at least to the components which are needed to establish the communication with the smart phone 250.

When the power supply OFF operation is performed (Yes in step S300), the digital camera 100 according to the above described embodiments keeps the supply of power only to some components of the digital camera 100 (S301). As a result, the power consumption of the digital camera 100 can be reduced. However, the idea of the above described embodiments is not limited to that. When the power supply OFF operation is performed, the digital camera 100 may keep the supply of power to all of the components to which power has been supplied. Also by that control, the user is not required to operate both of the digital camera 100 and the smart phone 250 at the same time to transfer the images as in the above described embodiments, therefore, the digital camera 100 can improve convenience.

In the above described embodiment, the communication between the digital camera 100 and the smart phone 250 is established by the digital camera 100 functioning as an access point. However, the idea of the above described embodiments is not limited to that. That is, an apparatus other than the digital camera 100 may function as the access point. For example, the smart phone 250 may have the access point function. In that case, the communication is established by the digital camera 100 issuing a connection request to the smart phone 250 which is the access point. Alternatively, the communication between the digital camera 100 and the smart phone 250 may be established via an access point other than the digital camera 100 and the smart phone 250. Further, the digital camera 100 and the smart phone 250 may establish the communication in ad hoc mode. In a word, the digital camera 100 only needs to be adapted to keep ready to establish the communication with another communication apparatus within a predetermined period of time even when the power supply OFF operation is performed. The idea of the present embodiments can be also applied to the digital camera 100 with the above described configuration.

In the above described embodiments, the controller 130 of the digital camera 100 determines whether an image to be sent to the smart phone 250 is left (S306). Then, when an image to be sent to the smart phone 250 is not left (Yes in step S306), the controller 130 of the digital camera 100 disconnects the communication with the smart phone 250 (S307). However, the idea of the above described embodiments is not limited to that. That is, an apparatus other than the digital camera 100 may disconnect the communication. For example, the smart phone 250 may disconnect the communication with the digital camera 100. In that case, when finishing sending all of the images to be sent, the digital camera 100 notifies the smart phone 250 of the completion of sending of the all images. When receiving the notification of sending completion from the digital camera 100, the smart phone 250 disconnects the communication with the digital camera 100 (corresponds to step S307). When the communication with the smart phone 250 is disconnected, the controller 130 of the digital camera 100 stops the supply of power to all of the components of the digital camera 100 (corresponds to S308). In short, the digital camera 100 is configured to cause the communication between the digital camera 100 and the smart phone 250 to be disconnected when an image to be sent from the digital camera 100 to the smart phone 250 is not left. The idea of the present embodiments can be applied to the digital camera 100 with that configuration.

In the above described embodiments, when the predetermined period of time has passed without a connection request sent from the smart phone 250 (Yes in step S309), the controller 130 of the digital camera 100 stops the supply of power to all of the components of the digital camera 100 (S310). That is, since the supply of power to the components which are not associated with the communication function has stopped in step S301, the controller 130 of the digital camera 100 stops the supply of power to the rest of the components which are associated with the communication function (the communication unit 171, the memory card 140, the card slot 141, and the like). However, the idea of the above described embodiments is not limited to that. That is, even after the supply of power to all of the components is stopped (S310), the controller 130 of the digital camera 100 may intermittently supply power to the components which are associated with the communication function. However, in that case, when stopping the supply of power (S310), the controller 130 keeps the supply of power to the controller 130 itself.

As a result, even when a connection request is not sent from the smart phone 250 to the digital camera 100 within the predetermined period of time (Yes in step S309), the digital camera 100 is given an opportunity to make the communication with the smart phone 250 established.

Here, the intermittent supply of power is specifically performed as below. In the case where the controller 130 of the digital camera 100 has intermittently supplied power to the communication function and succeeded in establishing the communication with the smart phone 250 within a predetermined period of time, the controller 130 keeps the communication with the smart phone 250 until the controller 130 finishes sending image data to be sent. Then, when finishing sending image data to be sent, the controller 130 stops the supply of power to the communication function. On the other hand, in the case where the controller 130 has intermittently supplied power to the communication function but cannot establish the communication state with the smart phone 250 within the predetermined period of time, the controller 130 stops the supply of power to the communication function. Then, after a predetermined period of time, the controller 130 of the digital camera 100 intermittently supplies power to the communication function again. As described above, the digital camera 100 may continue with the intermittent operation of the communication function even after the power supply OFF operation.

As a result, the digital camera 100 intermittently activates the communication function even after the power supply OFF operation, thus the digital camera 100 is given an opportunity to establish the communication with the smart phone 250. In addition, since the communication function is intermittently activated, the power consumption can be reduced as compared with the case where the power supply is always switched ON.

Further, in the above described embodiments, even when the digital camera 100 receives the power supply OFF operation, the digital camera is the communication apparatus which keeps ready to establish the communication with another communication apparatus for the predetermined time period. However, the idea of the above described embodiments can be applied to a device (a smart phone, a tablet, or the like) which has a communication function to be able to communicate data such as images.

Further, although the digital camera 100 of the above described embodiments includes a lens, the idea of the above described embodiments is not limited to that. The idea of the above described embodiments may also be applied to a camera having a detachable lens.

Further, when the power supply OFF operation is performed (Yes in step S300), the digital camera 100 of the above described embodiments stops the supply of power to the components which are not associated with the communication (S301). However, when the power supply OFF operation is performed, the digital camera 100 may determine whether an image to be sent to the smart phone 250 is left. In that case, when the digital camera 100 determines that no image to be sent is left, the digital camera 100 stops the supply of power to all of the components of the digital camera 100 without waiting until the end of the predetermined period of time. On the other hand, when the digital camera 100 determines that an image to be sent is left, the digital camera 100 waits for a connection request from the smart phone 250 for a predetermined period of time as in the above described embodiments (steps S302 to S303, and S309).

The embodiments have been described above as examples of the art of the present disclosure. For this purpose, the detailed description and the attached drawings have been disclosed. Therefore, some of the elements described in the detailed description and shown in the attached drawings may be unnecessary to solve the problem. Therefore, the unnecessary element should not be instantly recognized as a necessary element merely because being described in the detailed description and shown in the attached drawings.

Further, the above described embodiments exemplify the art of the present disclosure. Therefore, The above described embodiments can be subject to various changes, substitutions, addition, omission and/or the like without departing from the scope of the claims and the their equivalent.

### INDUSTRIAL APPLICABILITY

The idea according to the present disclosure can be applied to communication apparatuses that can send data such as images through a communication.

What is claimed is:

1. A communication apparatus, comprising:
a receiver that receives an instruction to switch off the communication apparatus;
an obtaining unit that obtains data from a recording medium;
a communication unit that sends the obtained data to an other electronic device; and
a controller that controls power supply of the communication apparatus, wherein
the controller continuously supplies power at least to a predetermined component which needs power to be supplied to establish communication with the other electronic device for a predetermined period of time, after the receiver receives the instruction to switch off the communication apparatus.

2. The communication apparatus according to claim 1, wherein
the predetermined component which needs power to be supplied includes the communication unit and the controller.

3. The communication apparatus according to claim 1, wherein
the controller stops supply of power to a component other than the predetermined component which needs power to be supplied.

4. The communication apparatus according to claim 1, wherein
the controller keeps an access point function active to be ready to receive a connection request from the other electronic device for the predetermined period of time, after the receiver receives the instruction to switch off the communication apparatus.

5. The communication apparatus according to claim 1, wherein
the communication unit sends the obtained data to the other electronic device when the communication unit establishes communication with the other electronic device within the predetermined period of time, and
the controller switches off the communication apparatus when the communication unit finishes the sending of the obtained data to the other electronic device.

6. The communication apparatus according to claim 1, wherein
the communication unit sends the obtained data to the other electronic device when the communication unit establishes communication with the other electronic device within the predetermined period of time, and
the controller supplies power at least to the predetermined component which needs power to be supplied, for another predetermined period of time after the communication unit finishes the sending of the obtained data to the other electronic device.

7. The communication apparatus according to claim 1, wherein
when the communication unit does not establish communication with the other electronic device within the predetermined period of time, the controller switches off the communication apparatus.
